(19) United States
(12) Patent Application Publication
(10) Pub. No.: US 2012/0154136 A1
(43) Pub. Date: Jun. 21, 2012

(54) SYSTEM TO PREVENT ACCIDENTAL LOCKING OF A PERSON IN A VEHICLE

(76) Inventor: Joseph E. Connelly, JR., Levittown, PA (US)

(21) Appl. No.: 12/970,260

(22) Filed: Dec. 16, 2010

(51) Int. Cl. B60Q 1/00

(52) U.S. Cl. 340/457

(57) ABSTRACT

A system for detecting presence of a living being in an unattended vehicle is disclosed. The system includes: a driver seat occupancy sensor; a living being detector; a vehicle door sensor and an alerting device. The alerting device is activated if the driver seat occupancy sensor detects that a driver is not in the seat for a predetermined period of time, and the vehicle door sensor detects that said vehicle doors are closed and the living being detector detects a living being in the vehicle after the predetermined period of time.

### FIELD OF THE INVENTION

This invention relates generally to vehicle safety devices and more particularly to safety devices to prevent the accidental entrapment of children or adults in a vehicle by the operator.

### BACKGROUND OF THE INVENTION

Accidental entrapment of children or disabled adults in vehicles is a well-known problem that often has tragic results. In some cases the entrapment is by a driver who has left a child in a locked vehicle and then has been distracted or has a physical or mental state that caused a lapse in memory or judgment or ability to return to the vehicle. In other cases, the vehicle, such as a bus has many occupants, and the driver is unaware that an occupant is still in the vehicle when the driver leaves the vehicle. Examples include passengers who have fallen asleep or children who might be hiding under seats. A patent in this field is U.S. Pat. No. 7,106,207 is directed to child automobile seats. Thus the need exists for a system to alert either the driver of the vehicle, passersby or law enforcement when any passenger is locked in an unattended vehicle

### SUMMARY OF THE INVENTION

A system for detecting presence of a living being in an unattended vehicle is disclosed. The system includes: a driver seat occupancy sensor; a living being detector; a vehicle door sensor and an alerting device. The alerting device is activated if the driver seat occupancy sensor detects that a driver is not in the seat for a predetermined period of time, and the vehicle door sensor detects that said vehicle doors are closed and the living being detector detects a living being in the vehicle after the predetermined period of time. The system of claim 1 wherein said alerting device is deactivated if said vehicle door sensor detects that a vehicle door is ajar after the activation of said alerting device.

In an embodiment, the alerting device is deactivated if the vehicle door sensor detects that a vehicle door is ajar after the activation of the alerting device. In a further embodiment, the alerting device is reactivated after a second predetermined period of time if the vehicle door sensor detects that all of said vehicle doors are again closed. In a further embodiment, the alerting device comprises an audible alarm.

In an embodiment the alerting device comprises a radio frequency transmitter or an infrared transmitter adapted to transmit an alert message. In a further embodiment, the alert message is transmitted at a frequency monitored by law enforcement personnel.

In an embodiment the alert message is transmitted to a satellite that relays said message to a monitoring system. In a further embodiment, the alert message is transmitted via a cellular network or a mesh network.

In a further embodiment the system includes an ignition key position sensor, wherein the alerting device is only activated if the ignition key position is in an off position.

In further embodiments, the living being detector is a motion detector, an infrared light sensor, a microphone, a switch or a vibration detector.

A method is disclosed for of detecting and alerting someone of the presence of a living being in an unattended vehicle. The method includes the steps of detecting that a driver seat of the vehicle is not occupied; detecting that all of the doors of the vehicle are locked; detecting the presence of the living being in the vehicle a predetermined period of time after said driver seat becomes unoccupied and said doors are locked and activating an alerting device.

In a further embodiment, there is disclosed a system for ensuring the welfare of a living being in an unattended vehicle having electrically controlled windows. The system included a driver seat occupancy sensor; a living being detector; and a vehicle door sensor such that at least one of said windows is opened if the driver seat occupancy sensor detects that a driver is not in the seat for a predetermined period of time, the vehicle door sensor detects that the vehicle doors are closed and the living being detector detects a living being in the vehicle after the predetermined period of time. In a further embodiment, the system includes a temperature sensor, wherein at least one of the windows are opened after the predetermined time if the temperature sensor indicates temperature above a predetermined threshold and the windows are opened after a second predetermined time if the temperature sensor indicates temperature below said threshold. In a further embodiment, in addition to the windows being lowered, the system includes an alerting device and the alerting device is activated when the widows are opened.

Other advantages and novel features of the invention will become apparent to those skilled in the art upon examination of the following detailed description of a preferred embodiment of the invention and the accompanying drawings.

### DESCRIPTION OF THE DRAWINGS

FIG. 1. is a block diagram of an exemplary system according to the invention;

FIG. 2 is a flow chart of an exemplary process according to the invention

### DESCRIPTION OF THE PREFERRED EMBODIMENT OF THE INVENTION

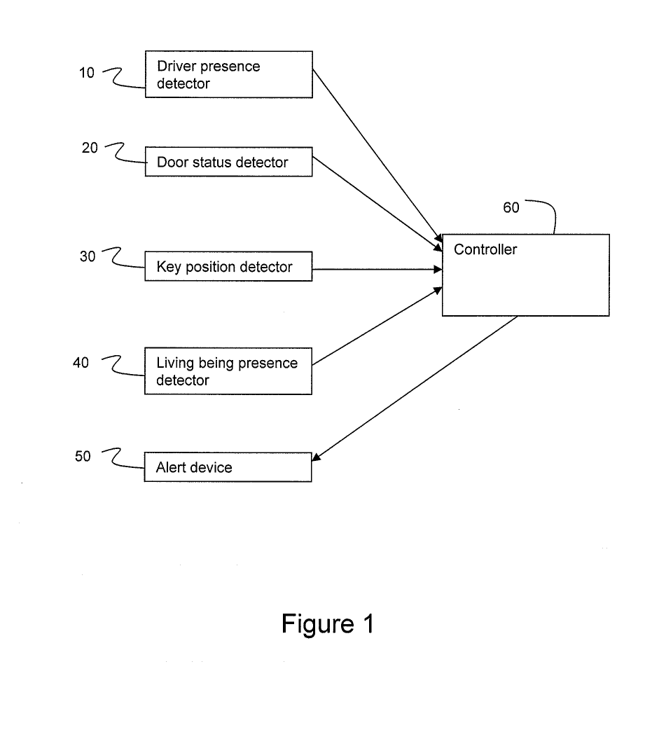

With reference to FIG. 1, an exemplary system includes a driver seat occupancy detector 10, a door status sensor 20, an ignition key position sensor 30, a living being presence detector 40, a controller 60 and an alerting device 50. The driver seat occupancy detector 10, door status sensor 20, ignition key position sensor 30, and living being presence detector 40 provide inputs to a controller 60. The controller is connected to and can activate the alerting device 50. The driver seat occupancy detector can be a switch, a heat detector a motion detector an camera, a broke light beam detector a strain gauge or the like. The door status detector can be a switch, an position encoder, a light sensor or the like. the ignition key position sensor can be a switch or an encoder or the like. The living being presence detector 40 can be a heat sensing motion detector, a switch in a seat, a vibration detector, a broken light beam detector; a camera equipped with image recognition; an infrared light detector or a sound detector. The alerting device can be an audible alarm, a control to flash the vehicle lights, a radio frequency transmitter; a satellite communications transmitter; a cellular network transmitter, a mesh network transmitter; an infrared signal transmitter or the like. Known radio frequency systems include LoJack® vehicle location system and OnStar® satellite communication system. The controller 60 can be a dedicated microprocessor for the alert system. The controller can also be a vehicle computer used for other purposes as well such as a dashboard display computer, an engine control computer or the like. The sensors and alert device can communicate with the controller via the known automobile standard CAN bus, by simple wire connections, by fiber optics or wirelessly.

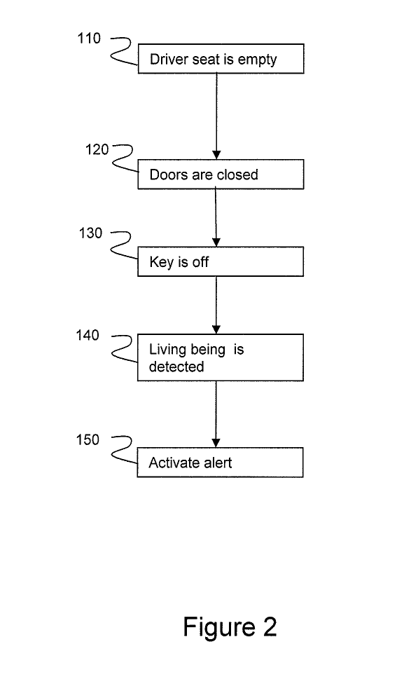

Referring to FIG. 2, In an exemplary system, the alerting device is activated 150 if the driver seat occupancy sensor detects that a driver is not in the seat for a predetermined period of time such as two minutes 110, the vehicle door sensor detects that the vehicle doors are closed 120, the key position sensor indicates the ignition is in the off 130 position and the living being detector detects a living being in the vehicle after the predetermined period of time 140. In an exemplary embodiment, the driver seat occupancy sensor detects a driver if more than 100 pounds is applied to the seat.

In a further embodiment, the alerting device is deactivated if the vehicle door sensor detects that a vehicle door is ajar after the activation of the alerting device. The alerting device is reactivated after a second predetermined period of time if the vehicle door sensor detects that all of said vehicle doors are again closed.

In an exemplary embodiment, the system will sound the vehicle horn and flash its lights if a living being is detected and the car is closed after the driver has left. Audible signals can include the SOS Mores Code pattern or 911 in Morse code. In a further embodiment, the system will lower at least one window. This system can be augmented by including an interior temperature sensor that will only lower the window right away if the car is too hot, but will also lower the window after a longer period of time to ensure fresh air.

In a further embodiment, the system includes a GPS receiver to locate the vehicle and the system transmits vehicle identification and location to a satellite. The satellite relays this information to a dedicated ground system specifically directed to alerting for persons trapped in vehicles. The ground system contacts law enforcement for the location of the vehicle with a prerecorded message stating the possibility of a trapped person at the indicated location. In an alternate embodiment, the system uses a cellular network to perform the same operation.

One skilled in the art would recognize that alternate embodiments are possible and covered by the claims without departing from the spirit of the invention.

We claim:

1. A system for detecting presence of a living being in an unattended vehicle comprising:
a driver seat occupancy sensor;
a living being detector;
a vehicle door sensor and
an alerting device, wherein
said alerting device is activated if said driver seat occupancy sensor detects that a driver is not in the seat for a predetermined period of time, said vehicle door sensor detects that said vehicle doors are closed and said living being detector detects a living being in the vehicle after said predetermined period of time.

2. The system of claim 1 wherein said alerting device is deactivated if said vehicle door sensor detects that a vehicle door is ajar after the activation of said alerting device.

3. The system of claim 2, wherein said alerting device is reactivated after a second predetermined period of time if said vehicle door sensor detects that all of said vehicle doors are again closed.

4. The system of claim 1, wherein said alerting device comprises an audible alarm.

5. The system of claim 1, wherein said alerting device comprises a radio frequency transmitter or an infrared transmitter adapted to transmit an alert message.

6. The system of claim 5, wherein said alert message is transmitted at a frequency monitored by law enforcement personnel.

7. The system of claim 6, where in said alert message is transmitted to a satellite that relays said message to a monitoring system.

8. The system of claim 5, wherein said alert message is transmitted via a cellular network or a mesh network.

9. The system of claim 1, further comprising an ignition key position sensor, wherein said alerting device is only activated if the ignition key position is in an off position.

10. The system of claim 1, wherein said living being detector is selected from the group consisting of: a motion detector, an infrared light sensor, a microphone, a switch and a vibration detector.

11. A method of detecting and alerting someone of the presence of a living being in an unattended vehicle comprising:
detecting that a driver seat of the vehicle is not occupied;
detecting that all of the doors of the vehicle are locked;
detecting the presence of the living being in the vehicle a predetermined period of time after said driver seat becomes unoccupied and said doors are locked and
activating an alerting device.

12. A system for ensuring the welfare of a living being in an unattended vehicle having electrically controlled windows comprising:
a driver seat occupancy sensor;
a living being detector;
a vehicle door sensor and
wherein
at least one of said windows is opened if said driver seat occupancy sensor detects that a driver is not in the seat for a predetermined period of time, said vehicle door sensor detects that said vehicle doors are closed and said living being detector detects a living being in the vehicle after said predetermined period of time.

13. The system of claim 12 further comprising a temperature sensor, wherein at least one of said windows are opened after said predetermined time if the temperature sensor indicates temperature above a predetermined threshold and said windows are opened after a second predetermined time if said temperature sensor indicates temperature below said threshold.

14. The system of claim 12 further comprising an alerting device, wherein said alerting device is activated when said widows are opened.
